(19) United States
(12) Patent Application Publication
(10) Pub. No.: US 2025/0062353 A1
(43) Pub. Date: Feb. 20, 2025

(54) COMPOSITION FOR FORMING ANODE OF LITHIUM SECONDARY BATTERY

(71) Applicants: Hyundai Motor Company, Seoul (KR); Kia Corporation, Seoul (KR); Korea Kumho Petrochemical Co., Ltd., Seoul (KR)

(72) Inventors: Hyun Jeong Kim, Suwon (KR); Byung Yong Lee, Anyang (KR); Won Yeong Ryu, Daejeon (KR); June Park, Daejeon (KR); Bo Na Choi, Daejeon (KR)

(21) Appl. No.: 18/510,957

(22) Filed: Nov. 16, 2023

(30) Foreign Application Priority Data
Aug. 14, 2023 (KR) 10-2023-0106486

(51) Int. Cl. H01M 4/62; C08K 3/04; H01M 4/583; H01M 10/052

(52) U.S. Cl. CPC H01M 4/622; C08K 3/04; H01M 4/583; H01M 4/625; H01M 10/052; C08K 2201/001; C08K 2201/014; H01M 2004/021; H01M 2004/027; H01M 2220/20

(57) ABSTRACT

disclosureDisclosed are, inter alia, a composition for forming an anode of a lithium secondary battery including an anode active material, a conductive material, and a binder. Particularly, the binder contains a triblock copolymer which has a soft block derived from an aliphatic or alicyclic diene-based monomer and forming a rubbery phase at a room temperature; and a first hard block and a second hard block connected to both ends of the soft block, respectively, derived from an aromatic ring-containing ethylenically unsaturated monomer, and forming a glassy phase at a room temperature, and wherein the binder includes particles with an average diameter (D₅₀) of 1 μm or more and 50 μm or less.

### CROSS REFERENCE TO RELATED APPLICATION

The present application claims priority to Korean Patent Application No. 10-2023-0106486, filed on Aug. 14, 2023, the entire contents of which is incorporated herein for all purposes by this reference.

### TECHNICAL FIELD

The present disclosure relates to a composition for forming an anode of a lithium secondary battery and the composition includes a binder containing a triblock copolymer which has a soft block and a hard block.

### BACKGROUND

A lithium secondary battery has been widely applied in the portable electronic device market since it was first commercialized in the 1990s, and continue to receive attention as the most researched energy storage system. Because of the characteristics of the lithium secondary battery, such as high driving voltage, high energy density, low self-discharge rate, high-rate performance, and long cycle stability, the lithium secondary battery meets suitable requirements as an energy source for an electric vehicle.

Nevertheless, the lithium secondary battery applied to the electric vehicle faces three major issues: safety, operating time, and cost. Issues of the safety and the operating time can be solved through an all-solid-state battery, but the cost is a factor that hinders the widespread application of the lithium secondary battery, which results in conducting much research to save the cost of the lithium secondary battery.

Reducing the energy consumption required to manufacture the lithium secondary battery or increasing its electrode thickness is one of the most effective ways to save the manufacturing cost of the lithium secondary battery. In the conventional technology for manufacturing the electrode, the electrode was formed by casting a slurry mixed with an electrode active material, a polymer binder, and a conductive additive in water or an organic solvent onto a current collector, drying and pressing the slurry. However, since the energy required to prepare the slurry and coat it on the current collector in this way accounts for about 50% of the energy consumed in the entire manufacturing process, in order to save the manufacturing cost of the lithium secondary battery, a research had been conducted on a process for manufacturing the electrode in dry manner without the solvent.

Even though much research has been conducted on the technology for manufacturing the electrode in the dry manner, there is still a need for research and development on technology for manufacturing in a dry manner an anode with excellent mechanical properties such as moldability, electrochemical stability, and tensile strength, as well as on a composition for forming the anode.

### SUMMARY

In preferred aspects, the present disclosure provides a composition for forming an anode of a lithium secondary battery. The composition includes a binder containing a triblock copolymer which has a hard block contributing to excellent mechanical properties and a soft block having flexibility. Such a composition is not only easy to mold and stable at a negative potential, but also can strongly bind to an anode active material. In addition, it has excellent tensile strength and forms a three-dimensional network which can strongly bind to the anode active material and a conductive material.

In certain aspect, the lithium secondary battery is an all-solid state battery. A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery.

In an aspect, provided is a composition for forming an anode of a lithium secondary battery and the composition includes an anode active material, a conductive material, and a binder. The binder includes (i) a triblock copolymer which has a soft block derived from an aliphatic or alicyclic diene-based monomer and forming a rubbery phase at a room temperature; and (ii) a first hard block and a second hard block connected to both ends of the soft block, respectively, derived from an aromatic ring-containing ethylenically unsaturated monomer and forming a glassy phase at a room temperature, and wherein the binder includes particles with an average diameter (D₅₀) of about 1 μm or greater and 50 μm or less.

As referred to herein, a rubbery phase or state is above the T_{g}, (glass transition temperature) of the material, i.e. where the material may be in a more rubbery state, and comparatively soft and flexible. Thus, when stated herein that the material forms a forming a rubbery phase at room temperature (e.g. 25° C.), the material may be above its glass transition temperature at room temperature (25° C.) and may in a comparatively rubbery or more flexible state.

As referred to herein, a glassy phase or state is below the T_{g}, (glass transition temperature) of the material, and where the material may be in a more rigid or glassy configuration. Thus, when stated herein that the material forms a glassy phase at room temperature (e.g. 25° C.), the material may be below its glass transition temperature at room temperature (25° C.) and may in a comparatively rigid or hardened state.

In some embodiments, the binder is a spherical shape and has an average sphericity of about 0.7 or greater and about 1.0 or less.

In some embodiments, the first and second glass transition temperatures corresponding to the first hard block and the second hard block, respectively, are about 50° C. or higher and about 120° C. or lower, and the third glass transition temperature corresponding to the soft block is about −120° C. or higher and about −50° C. or lower.

In some embodiments, the soft block is derived from an aliphatic diene-based monomer containing one or more selected from the group consisting of a butadiene-based monomer, a pentadiene-based monomer, and a hexadiene-based monomer.

In some embodiments, the butadiene-based monomer includes one or more selected from the group consisting of 1,2-butadiene, 1,3-butadiene, isoprene, and chloroprene.

In some embodiments, the first hard block and the second hard block are each independently derived from an aromatic ring-containing ethylenically unsaturated monomer containing one or more of a styrene-based monomer and an aromatic (meth) acrylic-based monomer.

In some embodiments, the styrene-based monomer includes one or more selected from the group consisting of styrene, a-methylstyrene, p-methylstyrene, p-methoxystyrene, p-ethoxystyrene, t-butoxystyrene, p-acetoxystyrene, p-chlorostyrene, p-bromostyrene, 2,4-dimethylstyrene, 3,5-dimethylstyrene, and 2,4,6-trimethylstyrene.

In some embodiments, the the aromatic (meth)acrylic-based monomer includes one or more selected from the group consisting of benzylacrylate, benzylmethacrylate, phenoxyacrylate, phenoxymethacrylate, phenylacrylate, phenylmethacrylate, phenylethylacrylate, and phenylethylmethacrylate.

In some embodiments, the anode active material includes one or more selected from the group consisting of a carbon-based active material, a silicon-based active material, a metal-based active material capable of alloying with lithium, and a lithium-containing active material.

In some embodiments, the conductive material includes one or more selected from the group consisting of a graphite, an activated carbon, a carbon black, an acetylene black, a Ketjen black, a carbon nanotube, a graphene, and a carbon fiber.

In some embodiments, the composition includes the first hard block and the second hard block in a combined amount of about 10 to 60% by weight based on the total weight of the triblock copolymer.

In some embodiments, a weight average molecular weight of each of the first hard block and the second hard block is about 9,000 g/mol or greater and about 20,000 g/mol or less.

In some embodiments, the composition includes the binder in an amount of about 3 to 15% by weight based on the total weight of the composition.

In an aspect, provided is an anode of a lithium secondary battery including the composition as described herein.

In an aspect, provided is a lithium secondary battery including the anode as described herein.

In an aspect, provided is a vehicle including the lithium secondary battery as described herein.

Using the composition for forming an anode of a lithium secondary battery according to various exemplary embodiments of the present disclosure makes it possible to manufacture not only a self-supporting film for the anode of the lithium secondary battery that is electrochemically stable even at a negative potential by combining with a strong interaction with an anode active material or a conductive material, has excellent tensile strength, and is easy to mold, but also the anode for the lithium secondary battery and the lithium secondary battery containing the self-supporting film.

Other aspects of the invention are disclosed infra.

### BRIEF DESCRIPTION OF THE DRAWINGS

FIG. 1 shows an exemplary internal structure of a binder included in a self-supporting film for an anode of a lithium secondary battery according to an exemplary embodiment of the present disclosure.

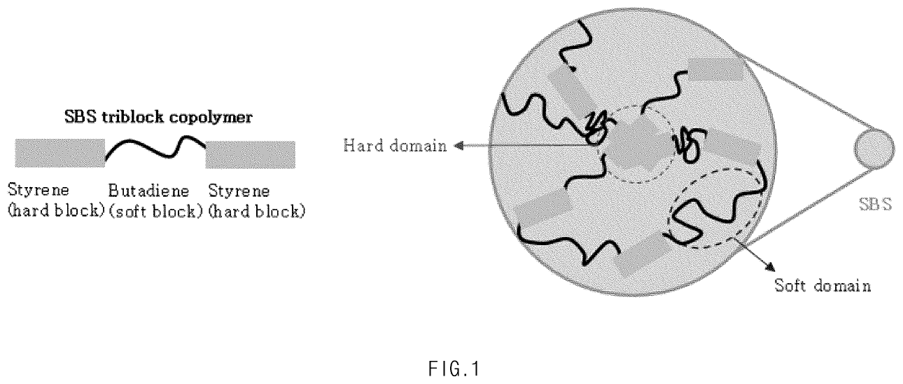

FIG. 2 shows an exemplary method of manufacturing an exemplary anode using an exemplary composition for forming the anode of a lithium secondary battery according to an exemplary embodiment of the present disclosure.

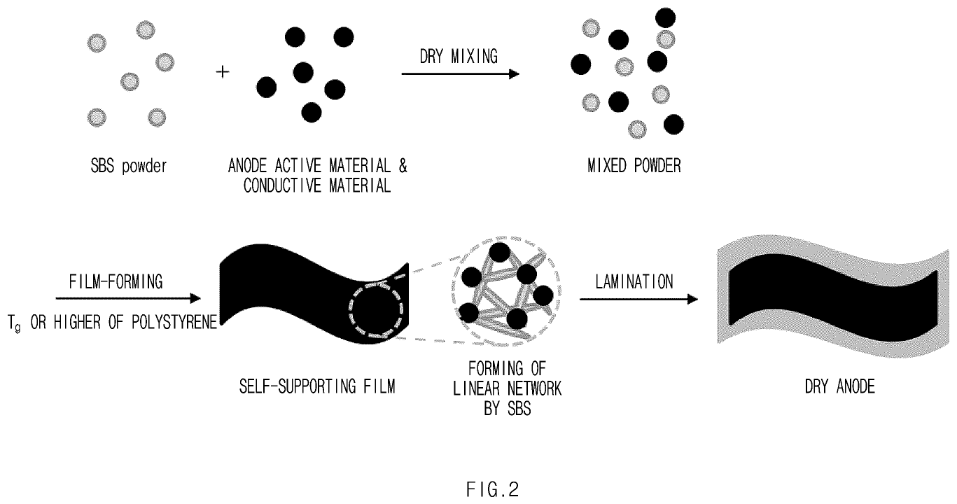

FIG. 3A shows an SEM image of SBS particles applied to a composition for forming an anode according to Example 1.

FIG. 3B shows an SEM image of SBS particles applied to a composition for forming an anode according to Comparative Example 1.

FIG. 3C is a diagram showing the results of particle size analysis for SBS particles applied to a composition for forming an anode according to Example 1.

FIG. 4A is an image that shows the result of visually observing the surface of an electrode manufactured using a composition for forming an anode according to Example 4.

FIG. 4B is an image that shows the result of visually observing the surface of an electrode manufactured using a composition for forming an anode according to Example 6.

### DETAILED DESCRIPTION

Hereinafter, a composition for forming an anode of a lithium secondary battery will be described in detail so that a person who has an ordinary knowledge in the technical field to which the present disclosure belongs can easily practice the present disclosure.

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

According to an embodiment of the present disclosure, a composition for forming an anode of a lithium secondary battery includes an anode active material, a conductive material, and a binder. The binder includes (i) a triblock copolymer which has a soft block derived from an aliphatic or alicyclic diene-based monomer and forming a rubbery phase at a room temperature; and (ii) a first hard block and a second hard block connected to both ends of the soft block, respectively, derived from an aromatic ring-containing ethylenically unsaturated monomer, and forming a glassy phase at a room temperature, and wherein the binder includes particles with an average diameter (D₅₀) of 1 μm or more and 50 μm or less.

The average diameter (D₅₀) of the binder refers to a diameter corresponding to 50% of the cumulative volume distribution measured by a laser diffraction/scattering particle size distribution measuring device.

The soft block may contain a repeating unit derived from an aliphatic diene-based monomer and/or an alicyclic diene-based monomer, and exhibit a rubbery phase at a room temperature. Particularly, the soft block may be derived from an aliphatic diene-based monomer containing at least one selected from the group consisting of a butadiene-based monomer, a pentadiene-based monomer, and a hexadiene-based monomer.

The butadiene-based monomer may include one or more selected from the group consisting of 1,2-butadiene, 1,3-butadiene, isoprene, and chloroprene.

The pentadiene-based monomer may include one or more selected from the group consisting of 1,2-pentadiene, 1,3-pentadiene, 1,4-pentadiene, 2,3-pentadiene, 2-methyl-1,3-pentadiene, 2-methyl-1,4-pentadiene, 2-methyl-2,3-pentadiene, 2-methyl-2,4-pentadiene, 3-methyl-1,3-pentadiene, 3-methyl-1,4-pentadiene, 4-methyl-1,3-pentadiene, 2-ethyl-1,3-pentadiene, 2-ethyl-1,4-pentadiene, 2-ethyl-2,4-pentadiene, 3-ethyl-1,3-pentadiene, 3-ethyl-1,4-pentadiene, 4-ethyl-1,3-pentadiene, 1-chloro-1,3-pentadiene, 1-chloro-2,4-pentadiene, 2-chloro-1,3-pentadiene, 3-chloro-1,3-pentadiene, 3-chloro-1,4-pentadiene, and 5-chloro-1,3-pentadiene.

The hexadiene-based monomer may include at least one selected from the group consisting of 1,2-hexadiene, 1,3-hexadiene, 1,4-hexadiene, 1,5-hexadiene, 2,3-hexadiene, 2,4-hexadiene, 2,5-hexadiene, 3,5-hexadiene, 2-methyl-1,3-hexadiene, 2-methyl-1,4-hexadiene, 2-methyl-1,5-hexadiene, 2-methyl-2,3-hexadiene, 2-methyl-2,4-hexadiene, 3-methyl-1,2-hexadiene, 3-methyl-1,3-hexadiene, 3-methyl-1,4-hexadiene, 3-methyl-1,5-hexadiene, 3-methyl-2,4-hexadiene, 3-methyl-2,5-hexadiene, 4-methyl-1,3-hexadiene, 4-methyl-1,4-hexadiene, 4-methyl-2,3-hexadiene, 5-methyl-1,3-hexadiene, 5-methyl-1,4-hexadiene, 2-ethyl-1,3-hexadiene, 2-ethyl-1,4-hexadiene, 3-ethyl-1,2-hexadiene, 3-ethyl-1,3-hexadiene, 3-ethyl-1,4-hexadiene, and 3-ethyl-1,5-hexadiene.

The triblock copolymer containing the soft block has the characteristics of excellent flexibility, extrusion moldability, and wear resistance.

The first hard block and the second hard block may contain a repeating unit derived from an ethylenically unsaturated monomer having an aromatic ring and exhibit a glassy phase at a room temperature. Particularly, the aromatic ring contained in the ethylenically unsaturated monomer may be a substituted or unsubstituted benzene ring or a substituted or unsubstituted naphthalene ring.

In addition, the aromatic ring may be connected to the main chain or side chain of the repeating unit of the first hard block and the second hard block, and may be preferably connected to the side chain of the repeating unit of the first hard block and the second hard block.

The first hard block and the second hard block may each independently be derived from an aromatic ring-containing ethylenically unsaturated monomer having at least one of a styrene-based monomer and an aromatic (meth)acrylic-based monomer.

The styrene-based monomer may include one or more selected from the group consisting of styrene, α-methylstyrene, p-methylstyrene, p-methoxystyrene, p-ethoxystyrene, t-butoxystyrene, p-acetoxystyrene, p-chlorostyrene, p-bromostyrene, 2,4-dimethylstyrene, 3,5-dimethylstyrene, and 2,4,6-trimethylstyrene.

The aromatic (meth)acrylic-based monomer may include one or more selected from the group consisting of benzylacrylate, benzylmethacrylate, phenoxyacrylate, phenoxymethacrylate, phenylacrylate, phenylmethacrylate, phenylethylacrylate, and phenylethylmethacrylate.

The first hard block and the second hard block can be strongly bonded to an anode active material or a conductive material through pi-pi interaction due to the aromatic ring structure contained in the repeating unit. In addition, the first hard block and the second hard block form a crosslink by physical bonding with a relatively low bonding energy, whereby, for example, a shape and size of the blocks can be maintained below their glass transition temperature, but a molding of the blocks can easily carried out above their glass transition temperature.

Further, the first hard block and the second hard block can impart high strength property to the triblock copolymer containing them.

A combined amount of the first hard block and the second hard block may be about 10 to 60% by weight, preferably about 15 to 55% by weight, more preferably about 20 to 50% by weight, based on the total amount of the triblock copolymer. When the amount of the first hard block and the second hard block satisfies the above numerical range, the bonding strength can be further improved due to strong interaction with the anode active material or the conductive material, so that the triblock copolymer can have more excellent moldability due to proper flexibility.

A weight average molecular weight of each of the first hard block and the second hard block may be about 9,000 g/mol or greater and about 20,000 g/mol or less, preferably about 9,500 g/mol or greater and about 20,000 g/mol or less, more preferably about 10,000 g/mol or greater and about 20,000 g/mol or less. When the weight average molecular weight of each of the first hard block and the second hard block satisfies the above numerical range, a physical crosslinking force between the binder and the anode active material or the conductive material can be improved to form a more stable three-dimensional network.

A first glass transition temperatures and a second glass transition temperatures corresponding to each of the first hard block and the second hard block may be about 50° C. or higher and about 120° C. or lower, and a third glass transition temperature corresponding to the soft block may be about −120° C. or higher and −50° C. or lower. Preferably, the first glass transition temperature and the second glass transition temperature are about 80° C. or higher and 120° C. or lower, and the third glass transition temperature is about −120° C. or higher and about −80° C. or lower. More preferably, the first glass transition temperature and the second glass transition temperature are about 80° C. or higher and about 110° C. or lower, and the third glass transition temperature is about −110° C. or higher and about −80° C. or lower. As such, when the first hard block, the second hard block, and the soft block contained in the triblock copolymer have the glass transition temperatures within the above numerical ranges, it is possible to carry out more reversible molding of a composition for forming an anode of a lithium secondary battery comprising a binder containing the triblock copolymer. In addition, durability and flexibility of the electrode manufactured from the composition are further improved so that a shape thereof can be maintained more effectively.

The soft block, the first hard block, and the second hard block contained in the triblock copolymer can each implement independent properties without affecting each other. In other words, the soft block can provide the flexibility, and the first hard block and the second hard block can provide the strong bonding force with the anode active material to the self-supporting film for the anode of the finally formed lithium secondary battery. In addition, since the soft block and the hard block have the glass transition temperatures different from each other, moldability of the triblock copolymer becomes easier when the self-supporting film for the anode is formed (calendering, etc.) at a temperature higher than the glass transition temperature of the hard block. When the self-supporting film is exposed to corresponding temperatures below the glass transition temperature of the hard block and above the glass transition temperature of the soft block immediately after forming the film, the triblock copolymer has the flexibility and maintains the high strength, so that the self-supporting film for the anode of the lithium secondary battery manufactured therefrom cannot be easily broken by an external stimulus.

The triblock copolymer is stable at a negative potential to suppress occurrence of a side reaction, and therefore, when the triblock copolymer is applied as the binder for the anode of the lithium secondary battery, the lifespan characteristic of the electrode can be enhanced.

The binder is substantially a spherical shape, and may be spherical or nearly spherical. Specifically, the binder may have an average sphericity of about 0.7 or greater and about 1.0 or less, preferably about 0.8 or greater and about 1.0 or less, more preferably about 0.9 or greater and about 1.0 or less. That is, before manufacturing the self-supporting film for the anode, the particles of the binder in the composition for forming the anode of the lithium secondary battery may be dispersed in the composition for forming the anode while maintaining a substantially spherical shape.

Herein, a sphericity of the binder is determined by measuring the long and short diameters of 10 randomly selected particles using an image of the binder particles observed with a scanning electron microscope (SEM), and calculating a ratio of the long and short diameters of each particle. The sphericity is an average value derived from the ratio of the long and short diameters of the 10 particles, and the closer the sphericity is to 1, the closer it can be judged to being spherical.

The anode active material may include one or more selected from the group consisting of a carbon-based active material, a silicon-based active material, a metal-based active material capable of alloying with lithium, and a lithium-containing active material.

The carbon-based active material may be, for example, a graphite, a hard carbon, a soft carbon, or a graphene. The graphite may be an artificial graphite, a natural graphite, a mixture of the artificial graphite and the natural graphite, a natural graphite coated with the artificial graphite, or a combination thereof.

The silicon-based active material may be, for example, Si, SiOₘ, a Si—C composite, a Si—Q alloy, or a combination thereof, where ₘ is 0<ₘ≤2, and Q is an alkali metal, an alkaline earth metal, an element from groups 13 to 16 of the periodic table, a transition metal, a rare earth element, or a combination thereof, and Si is excluded from Q.

The metal-based active material capable of alloying with the lithium may include, for example, B, Al, Ga, In, Ge, Sn, Pb, P, As, Sb, Bi, Mg, Ca, Zn, Cd, Pd, Ag, Au, Pt, or an alloy thereof or an oxide thereof.

The lithium-containing active material may be, for example, a lithium-containing titanium complex oxide (LTO).

The conductive material may include at least one selected from the group consisting of a graphite, an activated carbon, a carbon black, an acetylene black, a Ketjen black, a carbon nanotube, a graphene, and a carbon fiber.

The binder may be contained in an amount of about 3 to 15% by weight, preferably about 6 to 14% by weight, and more preferably about 10 to 14% by weight, based on the total weight of the composition for forming the anode of the lithium secondary battery. When an amount of the binder satisfies the above numerical range, a self-supporting film for the anode that has excellent tensile strength and is electrochemically stable even at a negative potential can be formed from the composition for forming the anode of the lithium secondary battery comprising the binder due to a strong interaction with the anode active material.

A film-forming process may be performed to form a self-supporting film for the anode using the composition for forming the anode of the lithium secondary battery. The film-forming process may be performed in a dry manner. In other words, the composition for forming the anode of the lithium secondary battery used in the film-forming process may be substantially free of a solvent. In case the film-forming process is performed in a wet manner, there is a limit to increasing a loading amount of the electrode due to a slurry of liquid state, and there are cases where a network structure between the binder and the active material/the conductive material cannot be formed. However, since the film-forming process according to the present disclosure is performed in the dry manner, it is possible to manufacture a lithium secondary battery in which a high loading amount of the electrode that realizes high energy density is possible and the network structure between the binder and the active material is formed more effectively.

The film-forming process may include calendering (rolling). In other words, the anode active material layer may be formed by passing the composition for forming the anode of the lithium secondary battery containing the anode active material, the conductive material, and the binder between a pair of rolls and pressing and rolling the composition. By applying external force such as shear force and tensile force through such calendaring, the self-supporting film for the anode of the lithium secondary battery can be manufactured finally.

Additionally, the triblock copolymer can form a three-dimensional network under a pressure at a temperature at which the film-forming process is performed. As described above, a domain of the active material or a domain of the conductive material and the binder are connected to each other to form the three-dimensional network, thereby making it possible to manufacture the anode of the lithium secondary battery with excellent tensile strength.

### EXAMPLE

Hereinafter, the present disclosure will be described through Examples in more detail. However, these Examples are merely intended to aid understanding the present disclosure, but are not intended to limit the scope of the present disclosure to these Examples in any way.

### <Example 1> Preparation 1 of a Composition for Forming an Anode

A graphite as an anode active material, a carbon black as a conductive material, and a SBS triblock copolymer (a glass transition temperature of polystyrene block: 100° C., a glass transition temperature of polybutadiene block: −100° C.) as a binder in a powder form were mixed at a mass ratio of 96:1:3 without a solvent.

Herein, the contents of the polystyrene block was 40.5% by weight based on the total weight of the SBS triblock copolymer. A molecular weight of the SBS triblock copolymer was 57,000 g/mol, of which a molecular weight of the polystyrene block was 11,500 g/mol and a molecular weight of the polybutadiene block was 34,000 g/mol.

### <Example 2> Preparation 2 of a Composition for Forming an Anode

A composition for forming an anode was prepared in the same method as that of Example 1, except that a mass ratio of the graphite, the conductive material, and the binder was 95:1:4.

### <Example 3> Preparation 3 of a Composition for Forming an Anode

A composition for forming an anode was prepared in the same method as that of Example 1, except that a mass ratio of the graphite, the conductive material, and the binder was 94:1:5.

### <Example 4> Preparation 4 of a Composition for Forming an Anode

A composition for forming an anode was prepared in the same method as that of Example 1, except that a mass ratio of the graphite, the conductive material, and the binder was 93:1:6.

### <Example 5> Preparation 5 of a Composition for Forming an Anode

A composition for forming an anode was prepared in the same method as that of Example 1, except that a mass ratio of the graphite, the conductive material, and the binder was 87:1:12.

### <Example 6> Preparation 6 of a Composition for Forming an Anode

A graphite as an anode active material, a carbon black as a conductive material, and a SBS triblock copolymer (a glass transition temperature of polystyrene block: 100° C., a glass transition temperature of polybutadiene block: −100° C.) as a binder in a powder form were mixed at a mass ratio of 93:1:6 without a solvent.

Herein, the contents of the polystyrene block was 31% by weight based on the total weight of the SBS triblock copolymer. A molecular weight of the SBS triblock copolymer was 73,000 g/mol, of which a molecular weight of the polystyrene block was 11,200 g/mol and a molecular weight of the polybutadiene block was 51,000 g/mol.

### <Comparative Example 1> Preparation 7 of a Composition for Forming an Anode

A composition for forming an anode was prepared in the same method as that of Example 1, except that the SBS in a pellet form (an average diameter (D₅₀): 5 mm) was used as the binder instead of the SBS in the powder form.

### <Experimental Example 1> Observation of SBS Particles

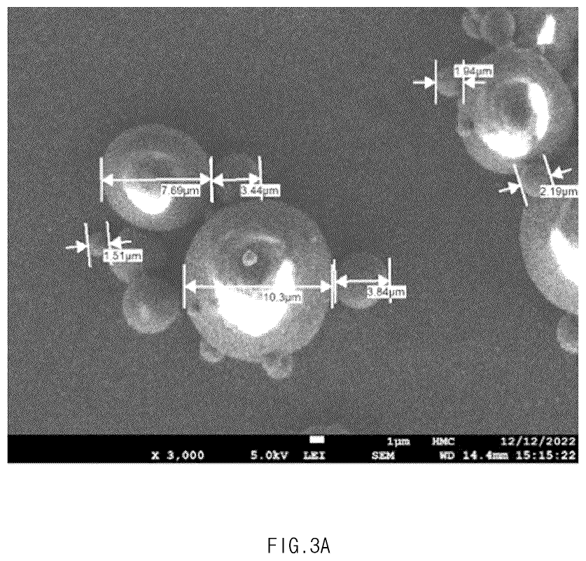

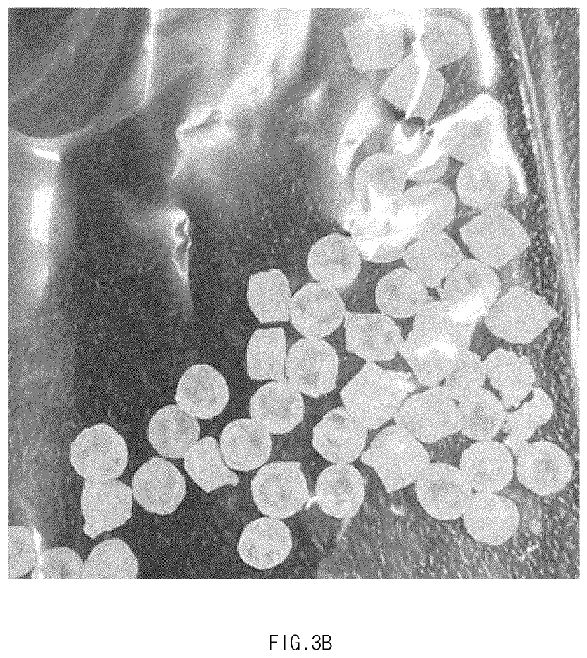

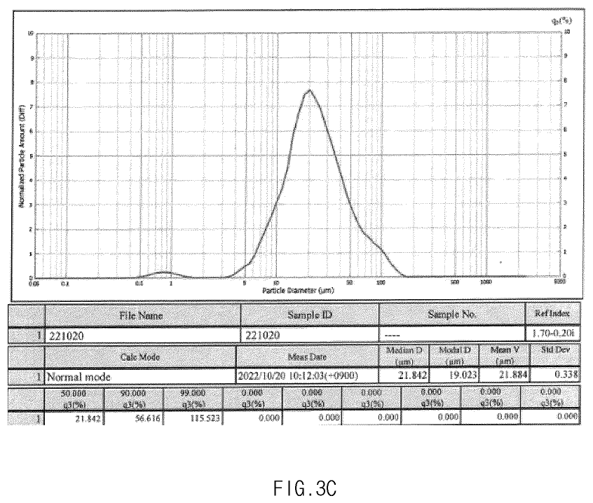

In order to observe a shape of the SBS particles, the SBS particles applied to the composition for forming the anode according to Example 1 and Comparative Example 1 were subjected to SEM imaging, and were shown in FIGS. 3A and 3B, respectively. FIG. 3A shows an SEM image of the SBS powder particles after being powdered, and FIG. 3B shows an SEM image of the SBS pellets before being powdered.

As shown in FIG. 3A, the SBS binder has a spherical particle shape even after being powdered.

Further, as a result of analyzing a particle size of the SBS particles applied to the composition for forming the anode according to Example 5 using a particle size analyzer (Model name: SALD-2300, Manufacturer: SHIMADZU), an average diameter (D₅₀) of the particles was about 20 μm (see FIG. 3C). In addition, in the case of the SBS particles applied to the composition for forming the anode according to Comparative Example 1, an average diameter (D₅₀) of the particles was confirmed to be about 0.5 cm. Accordingly, it could be confirmed that the SBS particles according to Example 1 after being powdered can form a smaller size of the SBS particles.

### <Comparative Example 2> Preparation 8 of a Composition for Forming an Anode

A composition for forming an anode was prepared in the same method as that of Example 1, except that the PTTF was used as the binder instead of the SBS.

### <Experimental Example 2> Observation of Whether a Self-Supporting Film for an Anode is Formed According to a Film-Forming Temperature

In order to observe the effect of a film-forming temperature on formation of a self-supporting film for an anode, the composition for forming the anode according to Example 4 was formed to a film by rolling the composition using a two-roll press heated to a temperature of 120° C., whereas the composition for forming the anode according to Example 4 was formed to a film by rolling the composition using a two-roll press heated to a temperature of 80° C.

As a result, the film formation was observed well at 120° C., but no film formation was observed at a temperature of 80° C. This means that the film formation can be realized at a temperature of 100° C. or higher, which is the glass transition temperature of polystyrene contained in the triblock copolymer.

### <Experimental Example 3> Observation of Surface State of a Self-Supporting Film for an Anode According to the Contents of Polystyrene

In order to observe the effect of the contents of polystyrene contained in a SBS triblock copolymer on the surface state of a self-supporting film for an anode, the film-forming process was performed by rolling the compositions for forming the anode according to Examples 4 and 6 with a two-roll press heated to a temperature of 120° C.

As a result, the film formation was observed for both of the compositions for forming the anode according to Examples 4 and 6. However, in the case of Example 6, which had relatively low contents of polystyrene block, the surface state of the self-supporting film was poorer than that of the self-supporting film formed by the composition for forming the anode of Example 4.

### <Experimental Example 4> Measurement of Tensile Strength of a Self-Supporting Film for an Anode

First, The self-supporting films for the anode were manufactured by rolling the compositions for forming the anode according to Example 1 (the contents of SBS binder: 3% by weight), Example 4 (the contents of SBS binder: 6% by weight, the contents of polystyrene block based on SBS: 40.5% by weight), Example 6 (the contents of SBS binder: 6% by weight, the contents of polystyrene block based on SBS: 31% by weight) and Comparative Example 1 (the contents of PTFE binder: 3% by weight), using a two-roll press under the following temperature conditions.

Each of the manufactured self-supporting films for the anode was punched to 2 cm in width and 6 cm in length to prepare samples of the self-supporting film, and the tensile strength was measured at a speed of 5 mm/min using UTM equipment. The measurement results of the tensile strength are shown in Table 1 below.

TABLE 1

| | | Film-Forming | Tensile |
|---|---|---|---|
| Composition | Contents of Binder | Temperature | Strength |
| Example 1 | SBS 3% by weight | 120° C. | 0.728 mPa |
| Example 1 | SBS 3% by weight | 140° C. | 0.556 mPa |
| Example 4 | SBS 6% by weight | 120° C. | 1.281 mPa |
| Example 6 | SBS 6% by weight | 120° C. | 0.874 mPa |
| Comparative | PTFE 3% by weight | 120° C. | 0.253 mPa |
| Example 1 | | | |

As shown in Table 1, the tensile strength decreases when the film-forming process is performed at a higher temperature based on the contents of the same binders. It is assumed that this is due to the fact that the higher the temperature at which the film-forming process is performed, the more stretching of the binder occurs, and when the temperature is lowered to a room temperature after the film-forming process, a shrinkage rate of the binder becomes relatively large, causing some of the three-dimensional network bonds within the binder to be broken.

On the other hand, in case the film-forming process is performed at the same temperature, the tensile strength is more excellent when the contents of the binder is 6% by weight than when it is 3% by weight, and that the tensile strength is more excellent when using the SBS than when using the PTFE as the binder (Comparative Example 1).

The above results may be because the SBS binder forms a three-dimensional network connecting between the active materials, between the conductive materials, or between the active material and the conductive material to bind them strongly.

Further, even if the film-forming process was performed at the same temperature using the composition for forming the anode containing the same contents of the SBS binders, the tensile strength of the manufactured self-supporting film for the anode was excellent in case the contents of the polystyrene block in the SBS was higher. In other words, as the contents of the polystyrene block in the SBS binder increases, the mechanical properties of the self-supporting film for the anode manufactured from the composition comprising the binder become superior.

### <Experimental Example 5> Observation of Whether an Anode is Manufactured

The self-supporting films were manufactured by rolling the compositions for forming the anode according to Examples 1 to 6 through a 2-roll press under the temperature conditions shown in Table 2 below. The self-supporting films were placed on one side of a copper foil (a current collector) coated with a primer layer, respectively, and laminated through a lamination roll maintained at 120° C. to manufacture anodes for a lithium secondary battery.

Table 2 below shows the results laminated under each condition, wherein O indicates a strong bond between the binder and the current collector without deformation of the self-supporting film for the anode, Δ indicates that the self-supporting film is broken or separated from the current collector when strong pressure is applied, and X indicates a case where the lamination itself is impossible.

TABLE 2

| | | Film-Forming | |
|---|---|---|---|
| Composition | Contents of Binder | Temperature | Lamination |
| Example 1 | SBS 3% by weight | 120° C. | Δ |
| Example 2 | SBS 4% by weight | 120° C. | ◯ |
| Example 3 | SBS 5% by weight | 120° C. | ◯ |
| Example 4 | SBS 6% by weight | 120° C. | ◯ |
| Example 5 | SBS 12% by weight | 120° C. | ⊚ |
| Example 6 | SBS 6% by weight | 120° C. | Δ |

When the lamination is performed with the self-supporting films for the anode formed at 120° C. using the compositions for forming the anode according to Examples 1 to 5, as the contents of the binder contained in the compositions increases, the binder and the current collector could be bonded more firmly. In particular, when the contents of the binder is as low as 3% by weight, the physical properties of the manufactured self-supporting film are poor, which also result in involving the poor physical properties of the anode manufactured after the lamination process, whereas when the binder content is 12% by weight, a strong anode can be formed by strongly bonding the self-supporting film for the anode to the copper foil. The above results may be because the higher the contents of the SBS binder, the more three-dimensional networks can be formed to connect between the anode active materials, between the conductive materials, or between the active material and the conductive material.

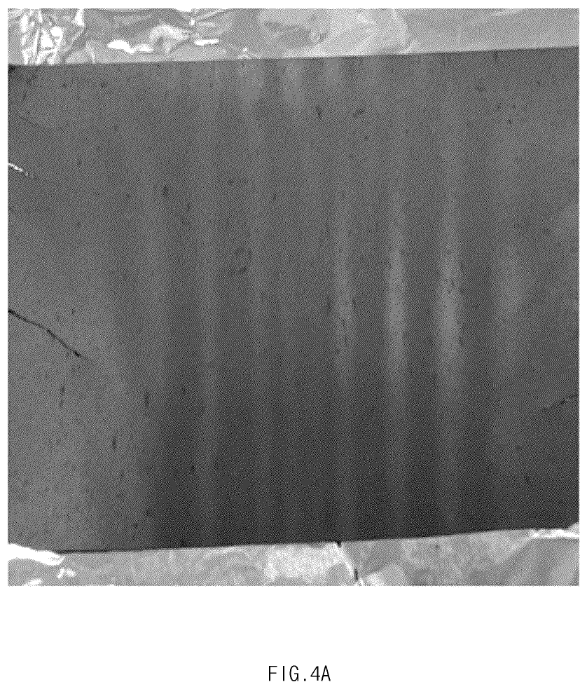

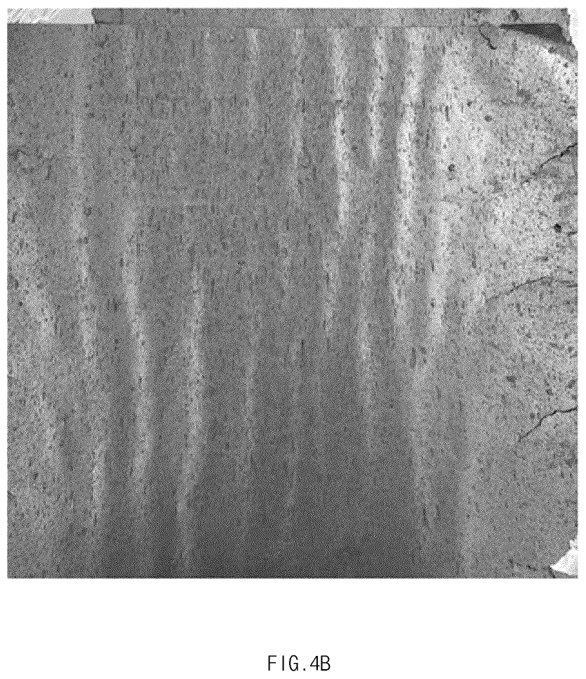

Meanwhile, in order to observe whether the anode is manufactured according to the contents of the polystyrene block contained in the SBS binder, the film-forming process was performed at a temperature of 120° C. using the compositions for forming the anode according to Example 4 and Example 6, and the anode after the lamination was shown FIGS. 4A and 4B, respectively. As a result, the anode manufactured using the composition for forming the anode according to Example 6 had inferior binding between the binder and the current collector, compared to the anode manufactured using the composition for forming the anode according to Example 4.

1. A composition for forming an anode of a lithium secondary battery comprising:
an anode active material,
a conductive material, and
a binder,
wherein the binder comprises:
a triblock copolymer which has a soft block derived from an aliphatic or alicyclic diene-based monomer and forming a rubbery phase at a room temperature; and
a first hard block and a second hard block connected to both ends of the soft block, respectively, derived from an aromatic ring-containing ethylenically unsaturated monomer and forming a glassy phase at a room temperature, and
wherein the binder includes particles having an average diameter (D₅₀) of about 1 μm or greater and 50 μm or less.

2. The composition of claim 1, wherein the binder is a spherical shape and has an average sphericity of about 0.7 or greater and about 1.0 or less.

3. The composition of claim 1, wherein the first and second glass transition temperatures corresponding to the first hard block and the second hard block, respectively, are about 50° C. or higher and about 120° C. or lower, and the third glass transition temperature corresponding to the soft block is about −120° C. or higher and about −50° C. or lower.

4. The composition of claim 1, wherein the soft block is derived from an aliphatic diene-based monomer containing one or more selected from the group consisting of a butadiene-based monomer, a pentadiene-based monomer, and a hexadiene-based monomer.

5. The composition of claim 4, wherein the butadiene-based monomer comprises one or more selected from the group consisting of 1,2-butadiene, 1,3-butadiene, isoprene, and chloroprene.

6. The composition of claim 1, wherein the first hard block and the second hard block are each independently derived from an aromatic ring-containing ethylenically unsaturated monomer containing one or more of a styrene-based monomer and an aromatic (meth)acrylic-based monomer.

7. The composition of claim 6, wherein the styrene-based monomer comprises one or more selected from the group consisting of styrene, α-methylstyrene, p-methylstyrene, p-methoxystyrene, p-ethoxystyrene, t-butoxystyrene, p-acetoxystyrene, p-chlorostyrene, p-bromostyrene, 2,4-dimethylstyrene, 3,5-dimethylstyrene, and 2,4,6-trimethylstyrene.

8. The composition of claim 6, wherein the aromatic (meth)acrylic-based monomer comprises one or more selected from the group consisting of benzylacrylate, benzylmethacrylate, phenoxyacrylate, phenoxymethacrylate, phenylacrylate, phenylmethacrylate, phenylethylacrylate, and phenylethylmethacrylate.

9. The composition of claim 1, wherein the anode active material comprises one or more selected from the group consisting of a carbon-based active material, a silicon-based active material, a metal-based active material capable of alloying with lithium, and a lithium-containing active material.

10. The composition of claim 1, wherein the conductive material comprises one or more selected from the group consisting of a graphite, an activated carbon, a carbon black, an acetylene black, a Ketjen black, a carbon nanotube, a graphene, and a carbon fiber.

11. The composition of claim 1, wherein the composition comprises the first hard block and the second hard block in a combined amount of about 10 to 60% by weight based on the total weight of the triblock copolymer.

12. The composition of claim 1, wherein a weight average molecular weight of each of the first hard block and the second hard block is about 9,000 g/mol or greater and about 20,000 g/mol or less.

13. The composition of claim 1, wherein the composition comprises the binder in an amount of about 3 to 15% by weight based on the total weight of the composition.

14. An anode of a lithium secondary battery comprising a composition of claim 1.

15. A lithium secondary battery comprising an anode of claim 14.

16. A vehicle comprising a lithium secondary battery of claim 15.
